(19) United States
(12) Patent Application Publication
(10) Pub. No.: US 2020/0007994 A1
(43) Pub. Date: Jan. 2, 2020

(54) BINAURAL HEARING AID AND METHOD OF REDUCING NOISE GENERATED BY TOUCHING HEARING AID

(71) Applicant: Unlimiter MFA Co., Ltd., Eden Island (SC)

(72) Inventors: Kuo-Wei KAO, Taipei (TW); Kuan-Li CHAO, Taipei (TW); Po-Jui WU, Taipei (TW); Jian-Ying LI, Taipei (TW); Cheng-Te WANG, Taipei (TW); Kuo-Ping YANG, Taipei (TW)

(21) Appl. No.: 16/135,044

(22) Filed: Sep. 19, 2018

(30) Foreign Application Priority Data
Jun. 27, 2018 (TW) 107122181

(51) Int. Cl. H04R 25/00

(52) U.S. Cl. CPC H04R 25/505; H04R 25/456; H04R 25/453

(57) ABSTRACT

A method of reducing a noise generated by touching a hearing aid includes: obtaining a left ear sound received by a left ear hearing aid and a right ear sound received by a right ear hearing aid; determining if a sound energy intensity difference between the left ear sound and the right ear sound is greater than an energy threshold; if so, determining a larger energy intensity between the left ear sound and the right ear sound; if the energy intensity of the left ear sound is larger, replacing the left ear sound with the right ear sound such that the left and right ear hearing aids both output the right ear sound.

### BACKGROUND OF THE INVENTION

### 1. Field of the Invention

The present invention relates to a binaural hearing aid and a method of reducing a noise generated by touching a hearing aid; more particularly, the present invention relates to a binaural hearing aid and a method for reducing the noise generated by touching the hearing aid to prevent the noise from irritating the user's ear.

### 2. Description of the Related Art

The binaural hearing aid is an aid tool designed for a hearing-impaired person. The binaural hearing aid has a left ear hearing aid and a right ear hearing aid. The left ear hearing aid and the right ear hearing aid each have a microphone, a processor, a speaker and a case. The microphone is located on the case and is for receiving the sound. The processor is located in the case and is for adjusting the sound received by the microphone (wherein the adjusting method is, for example, increasing the volume) to process the sound into an adjusted sound that the hearing-impaired person can hear. The speaker is located on the case and is for playing the adjusted sound to the hearing-impaired person such that the hearing-impaired person can hear the sound clearly.

However, if the case of either one of the hearing aids is touched by an external object (for example, the user accidentally touches the case with a finger or a helmet contacts the case when the user wears the helmet), then the external object will generate a great impact energy on the case; the impact energy will generate a knocking sound, the knocking sound will be received by the microphone on the case, and the processor will process the knocking sound into the adjusted sound with a great volume; therefore, the speaker of the hearing aid which is touched by the external object will play the knocking noise with the great volume such that the user's unilateral ear will hear the knocking noise; as a result, the user's ear may be uncomfortable and the hearing problem may be worsened because of the excessive irritation and the imbalance in volume caused by the knocking noise.

Therefore, there is a need to provide a method for reducing a noise generated by touching a hearing aid.

### SUMMARY OF THE INVENTION

It is an object of the present invention to provide a binaural hearing aid and a method for reducing the noise generated by touching the hearing aid so as to prevent the noise from irritating the user's ear.

To achieve the abovementioned object, a method of reducing a noise generated by touching a hearing aid of the present invention is applied to a binaural hearing aid. The binaural hearing aid includes a left ear hearing aid and a right ear hearing aid. The method of reducing a noise generated by touching the hearing aid includes: obtaining a left ear sound received by the left ear hearing aid and obtaining a right ear sound received by the right ear hearing aid; determining if a sound energy intensity difference between the left ear sound and the right ear sound is greater than an energy threshold; if the sound energy intensity difference is greater than the energy threshold, determining a larger energy intensity between the left ear sound and the right ear sound; if the energy intensity of the left ear sound is larger than the energy intensity of the right ear sound, replacing the left ear sound with the right ear sound such that the left ear hearing aid and the right ear hearing aid both output the right ear sound; if the right ear sound has a larger energy intensity than the left ear sound, replacing the right ear sound with the left ear sound such that the left ear hearing aid and the right ear hearing aid both output the left ear sound.

According to one embodiment of this present invention, the energy threshold is defined as a sound energy intensity difference between the left ear sound and the right ear sound of greater than 10%.

According to one embodiment of this present invention, the step of determining if the sound energy intensity difference between the left ear sound and the right ear sound is greater than the energy threshold further includes: calculating a calculation value which is the sound energy intensity difference between the left ear sound and the right ear sound divided by a sound energy intensity summation of the left ear sound and the right ear sound, and determining if an absolute value of the calculation value is greater than the energy threshold, wherein a range of the energy threshold is between 0 and 1.

According to one embodiment of this present invention, the method of reducing the noise generated by touching the hearing aid further includes: determining if the sound energy intensity of the left ear sound and the sound energy intensity of the right ear sound are both more than a specific energy value in a unit time; if the sound energy intensity of the left ear sound and the sound energy intensity of the right ear sound are both more than the specific energy value in the unit time, revising the sound energy intensity of the left ear sound and the sound energy intensity of the right ear sound.

According to one embodiment of this present invention, a formula for revising the sound energy intensity of the left ear sound is: a revised energy of the left ear sound=N×the sound energy intensity of the left ear sound×(a sound energy intensity summation of the left ear sound in the unit time+a sound energy intensity summation of the right ear sound in the unit time)/the sound energy intensity summation of the left ear sound in the unit time; a formula for revising the sound energy intensity of the right ear sound is: a revised energy of the right ear sound=N×the sound energy intensity of the right ear sound×(the sound energy intensity summation of the left ear sound in the unit time+the sound energy intensity summation of the right ear sound in the unit time)/the sound energy intensity summation of the right ear sound in the unit time, wherein N is a constant between 0.4 and 0.6.

According to one embodiment of this present invention, a sampling time for the sound energy intensity of the left ear sound and the sound energy intensity of the right ear sound is between 0.02 second and 0.2 second.

According to one embodiment of this present invention, the step of determining if a sound energy intensity difference between the left ear sound and the right ear sound is greater than an energy threshold further includes: determining if the sound energy intensity difference between the left ear sound and the right ear sound in a specific frequency band is greater than the energy threshold.

According to one embodiment of this present invention, the method of reducing the noise generated by touching the hearing aid further includes: determining if the left ear sound and the right ear sound are both non-voice sounds; if the left ear sound and the right ear sound are both non-voice sounds, executing the step of determining if the sound energy intensity difference between the left ear sound and the right ear sound is greater than the energy threshold.

According to one embodiment of this present invention, the ranges of the specific frequency bands are less than 8,000 HZ and between 14,000 HZ and 15,000 HZ.

### BRIEF DESCRIPTION OF THE DRAWINGS

These and other objects and advantages of the present invention will become apparent from the following descriptions of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a system structure drawing of the binaural hearing aid in the first embodiment of the present invention.

FIG. 2 illustrates a flowchart of the method of reducing the noise generated by touching the hearing aid in the first embodiment of the present invention.

FIG. 3 illustrates a flowchart of the first part of the method of reducing the noise generated by touching the hearing aid in the second embodiment of the present invention.

FIG. 3a illustrates a flowchart of the second part of the method of reducing the noise generated by touching the hearing aid in the second embodiment of the present invention.

### DETAILED DESCRIPTION OF THE PREFERRED EMBODIMENT

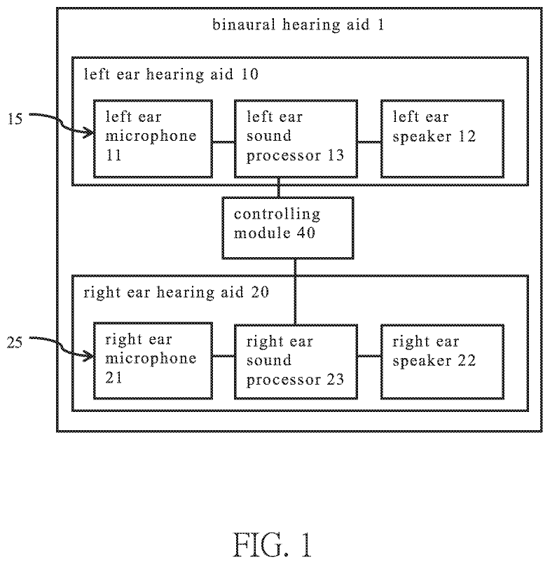

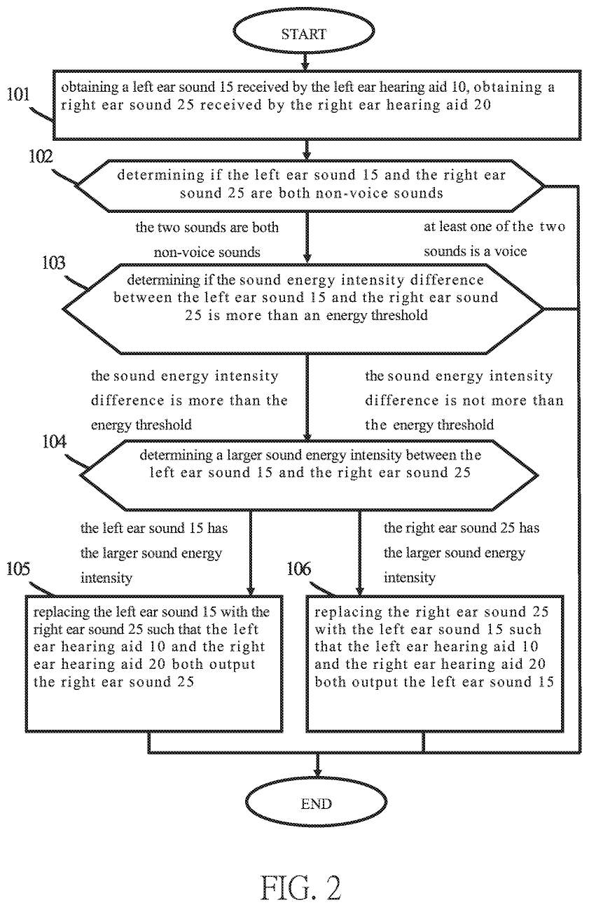

Please refer to FIG. 1 and FIG. 2 regarding the binaural hearing aid and the method of reducing a noise generated by touching a hearing aid in the first embodiment of the present invention. FIG. 1 illustrates a system structure drawing of the binaural hearing aid in the first embodiment of the present invention. FIG. 2 illustrates a flowchart of the method of reducing the noise generated by touching the hearing aid in the first embodiment of the present invention.

As shown in FIG. 1 and FIG. 2, in the first embodiment of the present invention, the method of reducing a noise generated by touching a hearing aid is programmed as a computer program and applied to a binaural hearing aid 1. The method of reducing the noise generated by touching the hearing aid is used for reducing the noise generated by touching the binaural hearing aid 1 to prevent the noise from irritating the ear of the user. The binaural hearing aid 1 is a hearing aid tool designed for the hearing-impaired person such that the hearing-impaired person can clearly hear the surrounding sound. The binaural hearing aid 1 includes a left ear hearing aid 10, a right ear hearing aid 20 and a controlling module 40.

In the first embodiment of the present invention, the left ear hearing aid 10 includes a left ear microphone 11, a left ear speaker 12 and a left ear sound processor 13. The left ear microphone 11 is used for receiving a left ear sound 15; the left ear sound 15 is the external sound generated by the external environment that the left ear microphone 11 is facing. However, the left ear sound 15 can also be a noise generated by touching the left ear hearing aid 10 (for example, a finger touching the left ear hearing aid 10 will cause the noise). The left ear sound processor 13 is electrically connected to the left ear microphone 11, the left ear speaker 12 and the controlling module 40. The left ear sound processor 13 is used for adjusting the left ear sound 15, such as increasing the volume, changing the frequency, and reducing the noise such that the left ear sound 15 is processed into an adjusted sound that the hearing-impaired person can clearly hear. The left ear speaker 12 is worn on the left ear of the hearing-impaired person to play the adjusted sound to the left ear of the hearing-impaired person. In the first embodiment of the present invention, the right ear hearing aid 20 includes a right ear microphone 21, a right ear speaker 22 and a right ear sound processor 23. The right ear microphone 21 is used for receiving a right ear sound 25; the right ear sound 25 is the external sound generated by the external environment that the right ear microphone 21 is facing. However, the right ear sound 25 can also be a noise generated by touching the right ear hearing aid 20. The right ear sound processor 23 is electrically connected to the right ear microphone 21, the right ear speaker 22 and the controlling module 40. The right ear sound processor 23 is used for adjusting the right ear sound 25, such as increasing the volume, changing the frequency, and reducing the noise such that the right ear sound 25 is processed into an adjusted sound that the hearing-impaired person can clearly hear. The right ear speaker 22 is worn on the right ear of the hearing-impaired person to play the adjusted sound to the right ear of the hearing-impaired person.

In the first embodiment of the present invention, the controlling module 40 is a chip which is electrically connected to the left ear hearing aid 10 and the right ear hearing aid 20 and is used for controlling the left ear hearing aid 10 and the right ear hearing aid 20. The controlling module 40 is used for obtaining the left ear sound 15 and the right ear sound 25 to determine if the left ear sound 15 and the right ear sound 16 are both non-voice sounds, and to determine if the sound energy intensity difference between the left ear sound 15 and the right ear sound 25 is greater than an energy threshold; the controlling module 40 is furthermore used for determining a larger sound energy intensity between the left ear sound 15 and the right ear sound 25 and for adjusting the sound played by the left ear hearing aid 10 and the right ear hearing aid 20 according to the determined result.

The computer program programmed with the method of reducing the noise generated by touching the hearing aid of the present invention is a firmware, which is embedded in the chip of the controlling module 40. When the left ear hearing aid 10 or the right ear hearing aid 20 receives the sound, the left ear sound processor 13 or the right ear sound processor 23 which receives the sound will send an electronic signal to the controlling module 40; at this moment, the firmware of the method of reducing the noise generated by touching the hearing aid embedded in the controlling module 40 will start automatically. First, the binaural hearing aid 1 executes step 101: obtaining a left ear sound received by the left ear hearing aid, and obtaining a right ear sound received by the right ear hearing aid.

The controlling module 40 requests the left ear hearing aid 10 or the right ear hearing aid 20 to send the left ear sound 15 received by the left ear hearing aid 10 and the right ear sound 25 received by the right ear hearing aid 20 to the controlling module 40 such that the controlling module 40 obtains the left ear sound 15 and the right ear sound 25.

Then the binaural hearing aid 1 executes step 102: determining if the left ear sound and the right ear sound are both non-voice sounds.

After the controlling module 40 obtains the left ear sound 15 and the right ear sound 25, the controlling module 40 will determine if the left ear sound 15 and the right ear sound 25 are both non-voice sounds. If at least one of the left ear sound 15 and the right ear sound 25 is a voice, then the method of reducing the noise generated by touching the hearing aid will not execute the following steps to prevent the voice being misjudged as the noise generated by touching the hearing aid and consequently being eliminated improperly by the following steps. The controlling module 40 uses the cross-correlation function as the discriminating condition for the voice and the noise generated by touching the hearing aid. The cross-correlation function of analyzing the audio information is already disclosed in the field of voice recognition and can be applied to analyze the time regularity of a sound information. If a value of the cross-correlation function approaches 1, which indicates that the sound information has an excellent sound regularity, then the sound information will be considered as a voice; smaller values of the cross-correlation function indicate more randomness (for example, the sound volume suddenly becomes large or small), which is the feature of a non-voice sound. Therefore, in this embodiment, if the cross-correlation function of the received sound is less than a set value (such as 0.5), the received sound will be considered as noise generated by touching the hearing aid; in contrast, if the cross-correlation function of the received sound is more than the set value, the received sound will be considered as a voice. However, the cross-correlation function is not the focus of this invention, and the cross-correlation function is already disclosed in the field of voice recognition, so there is no need for furthermore description.

If the controlling module 40 determines that the left ear sound 15 and the right ear sound 25 are both non-voice sounds, the binaural hearing aid 1 executes step 103: determining if the sound energy intensity difference between the left ear sound and the right ear sound is greater than an energy threshold.

After the controlling module 40 determines that the left ear sound 15 and the right ear sound 25 are both non-voice sounds, the controlling module 40 will sample the left ear sound 15 and the right ear sound 25 in a sampling time; thus, the analog signal of the sound can be converted to a discrete signal which can be easily processed by the electronic unit. The range of the sampling time of the present invention is between 0.02 second and 0.2 second, but the range of the sampling time is not limited to the abovementioned design.

After the controlling module 40 samples a sound, the controlling module 40 will analyze the energy intensities of the discrete signals of the left ear sound 15 and the right ear sound 25. In the present invention, the energy intensity of the left ear sound 15 or the right ear sound 25 is the energy size of the sound wave, which is the amplitude of the vibrating sound wave; the controlling module 40 will analyze the wave amplitude size of the discrete signal of the left ear sound 15 and the right ear sound 25. Then the controlling module 40 will determine if the sound energy intensity difference between the left ear sound 15 and the right ear sound 16 is greater than an energy threshold. In the first embodiment, the energy threshold is 10%, but the value of the energy threshold is not limited to that design. The energy threshold can be considered as a starting sensitivity for preventing the noise generated by touching, and the energy threshold can be adjusted to be any value between 0 to 1 according to the user requirement for switching the environmental noise automatic detection function of the system; a smaller energy threshold will allow easier execution of the function of preventing the noise.

If the sound energy intensity difference between the left ear sound 15 and the right ear sound 25 is not greater than the energy threshold, it means that the sound energy intensity of the left ear sound 15 and the sound energy intensity of the right ear sound 25 are about the same; the left ear hearing aid 10 and the right ear hearing aid 20 both receive the similar environmental sound, and neither the left ear hearing aid 10 nor the right ear hearing aid 20 is touched by an external object, such that there is no noise; thus, the binaural hearing aid 1 has no need to execute the following steps of the method of reducing the noise generated by touching the hearing aid. However, if the sound energy intensity difference between the left ear sound 15 and the right ear sound 25 is greater than the energy threshold, which means that one of the left ear sound 15 and the right ear sound 25 has an abnormal larger sound energy intensity, which also means that one of the left ear hearing aid 10 and the right ear hearing aid 20 is touched by an external object such that a noise is generated by the touching of the hearing aid, then the binaural hearing aid 1 will execute step 104:
determining a larger sound energy intensity between the left ear sound and the right ear sound.

After the controlling module 40 determines that the sound energy intensity difference between the left ear sound 15 and the right ear sound 25 is greater than the energy threshold, the controlling module 40 will determine a larger sound energy intensity between the left ear sound 15 and the right ear sound 25, wherein the side with the larger sound energy intensity is the same side as the hearing aid being touched by the external object and generating the noise. Therefore, if the controlling module 40 determines that the left ear sound 15 has a larger sound energy intensity than the right ear sound 25, the binaural hearing aid 1 will execute step 105: replacing the left ear sound with the right ear sound such that the left ear hearing aid and the right ear hearing aid both output the right ear sound.

If the controlling module 40 determines that the sound energy intensity of the left ear sound 15 is more than the sound energy intensity of the right ear sound 25, which means that the left ear hearing aid 10 is touched by an external object and receives a noise, such that the left ear sound 15 is an abnormal sound with the noise and the right ear sound 25 is a normal sound without the noise, then the controlling module 40 will send the right ear sound 25 to the left ear sound processor 13 and control the left ear sound processor 13 of the left ear hearing aid 10 to replace the left ear sound 15 with the right ear sound 25 such that the left ear speaker 12 outputs the right ear sound 25. Therefore, the left ear hearing aid 10 and the right ear hearing aid 20 will both output the right ear sound 25 without the noise, and the user will not be affected by the noise generated by the touching.

Please return to step 104. If the controlling module 40 determines that the sound energy intensity of the right ear sound 25 is larger than the sound energy intensity of the left ear sound 15, the binaural hearing aid 1 will execute step 106: replacing the right ear sound with the left ear sound such that the left ear hearing aid and the right ear hearing aid both output the left ear sound.

If the controlling module 40 determines that the sound energy intensity of the right ear sound 25 is greater than the sound energy intensity of the left ear sound 15, which means that the right ear hearing aid 20 is touched by an external object and receives the noise such that the right ear sound 25 is an abnormal sound with the noise and the left ear sound 15 is a normal sound without the noise, then the controlling module 40 will send the left ear sound 15 to the right ear sound processor 23 and control the right ear sound processor 23 of the right ear hearing aid 20 to replace the right ear sound 25 with the left ear sound 15 such that the right ear speaker 22 outputs the left ear sound 15. Therefore, the left ear hearing aid 10 and the right ear hearing aid 20 will both output the left ear sound 15 without the noise, and the user will not be affected by the noise generated by the touching.

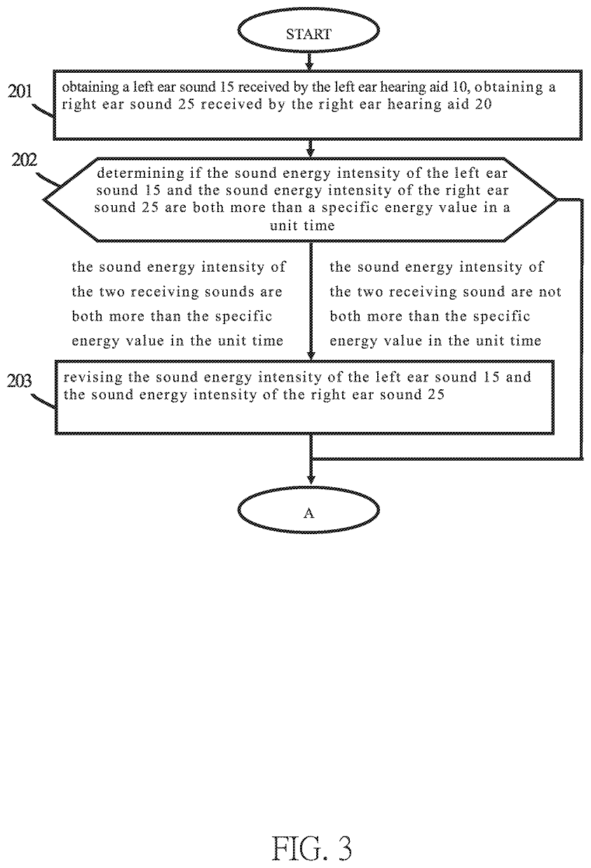

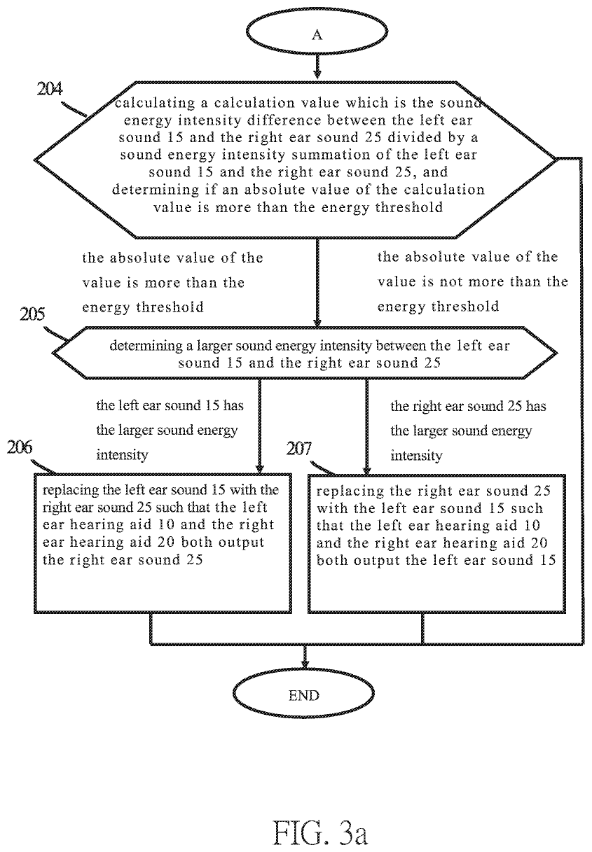

Please refer to FIG. 3 and FIG. 3a regarding the binaural hearing aid and the method of reducing a noise generated by touching a hearing aid in the second embodiment of the present invention. FIG. 3 illustrates a flowchart of the first part of the method of reducing a noise generated by touching a hearing aid in the second embodiment of the present invention. FIG. 3a illustrates a flowchart of the second part of the method of reducing a noise generated by touching a hearing aid in the second embodiment of the present invention.

As shown in FIG. 1, FIG. 3 and FIG. 3a, the difference between the second embodiment and the first embodiment is that, in the second embodiment, if the hearing-impaired person who uses the binaural hearing aid 1 is in an environment with high noise and uneven volume on the left and right sides (for example, the hearing-impaired person is in an airplane cabin and one of the ears is toward the engine), the left ear sound 15 and the right ear sound 25 will receive sounds with different volumes; therefore, the method of reducing the noise generated by touching the hearing aid and the binaural hearing aid 1 of the second embodiment are designed to revise the left ear sound 15 and the right ear sound 25 according to the volume of the surrounding environment to prevent misjudging the environmental sound as the noise of touching the hearing aid; the method of the second embodiment does not include the step of determining if the left ear sound 15 and the right ear sound 16 are both non-voice sounds. In the second embodiment, first, the binaural hearing aid 1 executes step 201; since step 201 is the same as step 101 of the first embodiment, there is no need for furthermore description. Then the binaural hearing aid 1 executes step 202: determining if the sound energy intensity of the left ear sound and the sound energy intensity of the right ear sound are both more than a specific energy value in a unit time.

The controlling module 40 determines if the sound energy intensity of the left ear sound 15 and the sound energy intensity of the right ear sound 25 are both more than a specific energy value in a unit time; if the sound energy intensity of the left ear sound 15 and the right ear sound 25 are both more than the specific energy value in the unit time, it means that the hearing-impaired person wearing the binaural hearing aid 1 is in an environment with high noise. In the second embodiment, the range of the unit time is between 0.05 second to 1 second, but the range of the unit time is not limited in the abovementioned design; the specific energy value, for example, is a sound volume more than 100 decibels (a sound volume of 100 decibels is approximately equal to the sound volume produced by a train moving on rails), but the range of the specific energy value is not limited to that design. If the neither the sound energy intensity of the left ear sound 15 nor the sound energy intensity of the right ear sound 25 is more than the specific energy value, it means that the hearing-impaired person is in a relatively quiet environment, so there is no need for the binaural hearing aid 1 to execute step 203 to revise the environmental sound, and the binaural hearing aid 1 can directly execute step 204. However, if the sound energy intensity of the left ear sound 15 and the sound energy intensity of the right ear sound 25 are both more than the specific energy value in the unit time, the binaural hearing aid 1 will execute step 203: revising the sound energy intensity of the left ear sound and the sound energy intensity of the right ear sound.

The controlling module 40 will control the left ear sound processor 13 of the left ear hearing aid 10 and the right ear sound processor 23 of the right ear hearing aid 20 to respectively revise the sound energy intensity of the left ear sound 15 and the sound energy intensity of the right ear sound 25. The formula which is executed by the left ear sound processor 13 for revising the sound energy intensity of the left ear sound 15 is as follows:

a revised energy of the left ear sound=N×the sound energy intensity of the left ear sound×(a sound energy intensity summation of the left ear sound in the unit time+a sound energy intensity summation of the right ear sound in the unit time)/the sound energy intensity summation of the left ear sound in the unit time. N is a constant which is between 0.4 to 0.6.

The formula which is executed by the right ear sound processor 23 for revising the sound energy intensity of the right ear sound 25 is as follows:

a revised energy of the right ear sound=N×the sound energy intensity of the right ear sound×(the sound energy intensity summation of the left ear sound in the unit time+the sound energy intensity summation of the right ear sound in the unit time)/the sound energy intensity summation of the right ear sound in the unit time. N is a constant which is between 0.4 to 0.6.

As shown in the actual experiment of the applicant, the abovementioned formula for revising the energy of the left ear sound 15 and the right ear sound 25 can preliminarily eliminate the interference caused by an environment with high noise and uneven volume on the left and right sides to prevent the controlling module 40 from misjudging that the uneven volume of the environmental sound as the noise of touching the hearing aid. Then the binaural hearing aid 1 will execute step 204: calculating a calculation value which is the sound energy intensity difference between the left ear sound and the right ear sound divided by a sound energy intensity summation of the left ear sound and the right ear sound, and determining if an absolute value of the calculation value is greater than the energy threshold.

Step 204 of the second embodiment is similar as step 103 of the first embodiment. The two steps are both the key steps for determining if the left ear hearing aid 10 or the right ear hearing aid 20 is touched by an external object and generates noise. However, in step 204 of the second embodiment, the controlling module 40 will further eliminate the external environmental noise effect for the left ear sound 15 and the right ear sound 25. First, the controlling module 40 will calculate the sound energy intensity difference between the left ear sound 15 and the right ear sound 25 in the specific frequency band; then the controlling module 40 will calculate a calculation value which is the sound energy intensity difference divided by a sound energy intensity summation of the left ear sound 15 and the right ear sound 25 in the specific frequency band; then the controlling module 40 will calculate an absolute value of the calculation value. By the abovementioned operation and adjustment, the controlling module 40 can average the sound energy intensity difference of the total volume of the environment to furthermore eliminate the sound energy influence caused by the environment with high noise and uneven volume on the left and right sides to obtain a more precise judgment value.

In addition, the controlling module 40 of the second embodiment only captures the sound energy intensities of the left ear sound 15 and the right ear sound 25 in a specific frequency band and ignores the sound energy intensities of the left ear sound 15 and the right ear sound 25 in other frequency bands. As shown by the actual experiment of the applicant, the frequency ranges of the noise generated by touching of the left ear hearing aid 10 and the right ear hearing aid 20 are under 8,000 HZ and between 14,000 and 15,000 HZ. Thus, the applicant sets the frequency ranges of under 8,000 HZ and between 14,000 and 15,000 HZ as the specific frequency bands; a sound with a frequency outside the specific frequency bands is not a noise generated by touching of the left ear hearing aid 10 and the right ear hearing aid 20, so a frequency outside the specific frequency bands can be ignored. Therefore, the sound energy influence caused by the environment with high noise and uneven volume on the left and right sides can be furthermore eliminated to obtain a more precise value for judgment.

By the abovementioned operation and the processing of only capturing the sound energy in specific frequency bands, the controlling module 40 can completely eliminate the influence of the high noise environment to obtain a precise absolute value of the calculation value. Thus, the controlling module 40 can determine if the absolute value of the value is greater than the energy threshold to determine if the left ear hearing aid 10 or the right ear hearing aid 20 is touched by an external object and generates noise. If the absolute value of the value is greater than the energy threshold, which means that one of the left ear hearing aid 10 and the right ear hearing aid 20 is touched by an external object, there is a need to execute the following step 205 to step 206 or step 207; however, step 205 to step 207 are the same as step 104 to step 106 in the first embodiment, so there is no need for furthermore description.

By the method of reducing the noise generated by touching a hearing aid of the binaural hearing aid 1 which uses the method of the present invention, the noise generated by the touching of the binaural hearing aid 1 can be reduced to prevent the noise from irritating the user's ear. In addition, the method of reducing the noise generated by touching the hearing aid can furthermore revise the interference caused by the surrounding environmental noise for the left ear sound 15 and the right ear sound 25 to prevent the surrounding environmental sound being misjudged as the noise of touching the hearing aid.

1. A method of reducing noise generated by touching hearing aid, applied to a binaural hearing aid, for reducing a noise caused by an external object which is directly touching the left ear hearing aid or the right ear hearing aid, wherein the binaural hearing aid comprises a left ear hearing aid and a right ear hearing aid, the method of reducing noise generated by touching hearing aid comprising:
obtaining a left ear sound received by the left ear hearing aid, and obtaining a right ear sound received by the right ear hearing aid;
determining if a sound energy intensity difference between the left ear sound and the right ear sound is greater than an energy threshold;
if the sound energy intensity difference is greater than the energy threshold, determining a larger energy intensity between the left ear sound and the right ear sound;
if the left ear sound has the larger energy intensity than the right ear sound because the external object is directly touching the left ear hearing aid to cause the noise, replacing the left ear sound with the right ear sound such that the left ear hearing aid and the right ear hearing aid both output the right ear sound; and
if the right ear sound has the larger energy intensity than the left ear sound because the external object is directly touching the right ear hearing aid to cause the noise, replacing the right ear sound with the left ear sound such that the left ear hearing aid and the right ear hearing aid both output the left ear sound.

2. The method of reducing noise generated by touching hearing aid as claimed in claim 1, wherein the energy threshold is defined as the sound energy intensity difference between the left ear sound and the right ear sound of more than 10%.

3. The method of reducing noise generated by touching hearing aid as claimed in claim 1, wherein the step of determining if the sound energy intensity difference between the left ear sound and the right ear sound is greater than the energy threshold further comprises:
calculating a calculation value which is the sound energy intensity difference between the left ear sound and the right ear sound divided by a sound energy intensity summation of the left ear sound and the right ear sound, and determining if an absolute value of the calculation value is greater than the energy threshold, wherein a range of the energy threshold is between 0 and 1.

4. The method of reducing noise generated by touching hearing aid as claimed in claim 3, further comprising:
determining if the sound energy intensity of the left ear sound and the sound energy intensity of the right ear sound are both more than a specific energy value in a unit time;
if the sound energy intensity of the left ear sound and the sound energy intensity of the right ear sound are both more than the specific energy value in the unit time, revising the sound energy intensity of the left ear sound and the sound energy intensity of the right ear sound.

5. The method of reducing noise generated by touching hearing aid as claimed in claim 4, wherein a formula for revising the sound energy intensity of the left ear sound is as follows:
a revised energy of the left ear sound=N×the sound energy intensity of the left ear sound×(a sound energy intensity summation of the left ear sound in the unit time+a sound energy intensity summation of the right ear sound in the unit time)/the sound energy intensity summation of the left ear sound in the unit time;
wherein a formula for revising the sound energy intensity of the right ear sound is as follows:
a revised energy of the right ear sound=N×the sound energy intensity of the right ear sound×(the sound energy intensity summation of the left ear sound in the unit time+the sound energy intensity summation of the right ear sound in the unit time)/the sound energy intensity summation of the right ear sound in the unit time;
wherein N is a constant between 0.4 and 0.6.

6. The method of reducing noise generated by touching hearing aid as claimed in claim 5, wherein a sampling time for the sound energy intensity of the left ear sound and the sound energy intensity of the right ear sound is between 0.02 second and 0.2 second.

7. The method of reducing noise generated by touching hearing aid as claimed in claim 6, wherein the step of determining if a sound energy intensity difference between the left ear sound and the right ear sound is greater than an energy threshold further comprises:
determining if the sound energy intensity difference between the left ear sound and the right ear sound in a specific frequency band is greater than the energy threshold.

8. The method of reducing noise generated by touching hearing aid as claimed in claim 7, further comprising:
determining if the left ear sound and the right ear sound are both non-voice sounds; and
if the left ear sound and the right ear sound are both non-voice sounds, executing the step of determining if the sound energy intensity difference between the left ear sound and the right ear sound is greater than the energy threshold.

9. The method of reducing noise generated by touching hearing aid as claimed in claim 8, wherein the ranges of the specific frequency bands are below 8,000 HZ and between 14,000 HZ and 15,000 HZ.

10. The method of reducing noise generated by touching hearing aid as claimed in claim 1, wherein a sampling time for sampling the sound energy intensity of the left ear sound and the sound energy intensity of the right ear sound is between 0.02 second and 0.2 second.

11. A binaural hearing aid, comprising:
a left ear hearing aid, for receiving a left ear sound;
a right ear hearing aid, for receiving a right ear sound; and
a controlling module, electrically connected to the left ear hearing aid and the right ear hearing aid, to reduce a noise caused by an external object which is directly touching the left ear hearing aid or the right ear hearing aid, wherein the controlling module is used for obtaining the left ear sound and the right ear sound and for determining if a sound energy intensity difference between the left ear sound and the right ear sound is greater than an energy threshold; if the sound energy intensity difference is greater than the energy threshold, determining a larger energy intensity between the left ear sound and the right ear sound; if the left ear sound has the larger energy intensity than the right ear sound because the external object is directly touching the left ear hearing aid to cause the noise, replacing the left ear sound with the right ear sound such that the left ear hearing aid and the right ear hearing aid both output the right ear sound; if the right ear sound has the larger energy intensity than the left ear sound because the external object is directly touching the right ear hearing aid to cause the noise, replacing the right ear sound with the left ear sound such that the left ear hearing aid and the right ear hearing aid both output the left ear sound.

12. The binaural hearing aid as claimed in claim 11, wherein the energy threshold is defined as the sound energy intensity difference between the left ear sound and the right ear sound of greater than 10%.

13. The binaural hearing aid as claimed in claim 11, wherein the controlling module is furthermore used for calculating a calculation value which is the sound energy intensity difference between the left ear sound and the right ear sound divided by a sound energy intensity summation of the left ear sound and the right ear sound, and determining if an absolute value of the calculation value is greater than the energy threshold, wherein a range of the energy threshold is between 0 and 1.

14. The binaural hearing aid as claimed in claim 13, wherein the controlling module is furthermore used for determining if the sound energy intensity of the left ear sound and the sound energy intensity of the right ear sound are both more than a specific energy value in a unit time; if the sound energy intensity of the left ear sound and the sound energy intensity of the right ear sound are both more than the specific energy value in the unit time, revising the sound energy intensity of the left ear sound and the sound energy intensity of the right ear sound.

15. The binaural hearing aid as claimed in claim 14, wherein a formula for revising the sound energy intensity of the left ear sound is as follows:
a revised energy of the left ear sound=N×the sound energy intensity of the left ear sound×(a sound energy intensity summation of the left ear sound in the unit time+a sound energy intensity summation of the right ear sound in the unit time)/the sound energy intensity summation of the left ear sound in the unit time;
wherein a formula for revising the sound energy intensity of the right ear sound is as follows:
a revised energy of the right ear sound=N×the sound energy intensity of the right ear sound×(the sound energy intensity summation of the left ear sound in the unit time+the sound energy intensity summation of the right ear sound in the unit time)/the sound energy intensity summation of the right ear sound in the unit time;
wherein N is a constant between 0.4 and 0.6.

16. The binaural hearing aid as claimed in claim 15, wherein a sampling time for the sound energy intensity of the left ear sound and the sound energy intensity of the right ear sound is between 0.02 second and 0.2 second.

17. The binaural hearing aid as claimed in claim 16, wherein the controlling module is furthermore used for determining if the sound energy intensity difference between the left ear sound and the right ear sound in a specific frequency band is greater than the energy threshold.

18. The binaural hearing aid as claimed in claim 17, wherein the controlling module is furthermore used for determining if the left ear sound and the right ear sound are both non-voice sounds; if the left ear sound and the right ear sound are both non-voice sounds, the controlling module will determine if the sound energy intensity difference between the left ear sound and the right ear sound is greater than the energy threshold.

19. The binaural hearing aid as claimed in claim 18, wherein the ranges of the specific frequency bands are less than 8,000 HZ and between 14,000 HZ and 15,000 HZ.

20. The binaural hearing aid as claimed in claim 11, wherein a sampling time for sampling the sound energy intensity of the left ear sound and the sound energy intensity of the right ear sound is between 0.02 second and 0.2 second.
